(19) United States
(12) Patent Application Publication
(10) Pub. No.: US 2018/0237240 A1
(43) Pub. Date: Aug. 23, 2018

(54) IMAGE FORMING APPARATUS AND IMAGE FORMING METHOD

(71) Applicants: KABUSHIKI KAISHA TOSHIBA, Tokyo (JP); TOSHIBA TEC KABUSHIKI KAISHA, Tokyo (JP)

(72) Inventor: Shinya Sugimoto, Mishima Shizuoka (JP)

(21) Appl. No.: 15/467,076

(22) Filed: Mar. 23, 2017

(30) Foreign Application Priority Data
Feb. 21, 2017 (JP) 2017-030212

(51) Int. Cl. B65H 3/52; G03G 15/00; B65H 1/04; B65H 1/26; B65H 3/06

(52) U.S. Cl. CPC B65H 3/5261; G03G 15/6529; B65H 1/04; B65H 2801/06; B65H 3/06; B65H 3/52; B65H 1/266

(57) ABSTRACT

According to one embodiment, an image forming apparatus includes a sheet accommodation unit, a paper sheet-feeding unit, an inclined surface portion, a resistance application member, and a transport unit. The sheet accommodation unit stacks sheets. The paper sheet-feeding unit feeds the sheets from the sheet accommodation unit. The inclined surface portion is provided in a paper sheet-feeding direction of the sheets. The resistance application member includes a protruding portion that protrudes more than the inclined surface portion. The transport unit is provided on a downstream side of the inclined surface portion in a transportation direction of the sheets. The transport unit transports the sheets.

### CROSS-REFERENCE TO RELATED APPLICATIONS

This application is based upon and claims the benefit of priority from Japanese Patent Application No. 2017-030212, filed Feb. 21, 2017, the entire contents of which are incorporated herein by reference.

### FIELD

Embodiments described herein relate generally to an image forming apparatus and an image forming method.

### BACKGROUND

The image forming apparatus feeds a sheet from a sheet accommodation unit toward a body transport path of an apparatus body. The image forming apparatus includes a sheet separation mechanism for preventing multiple-feeding of sheets.

As the sheet separation mechanism, for example, a feed reverse roller (FRR) paper sheet-feeding method, a separation claw method, and a friction pad method are known. For example, in the FRR method, when two sheets are subjected to multiple-feeding, the sheets can be separated. However, when three or more sheets are subjected to multiple-feeding, the sheets may not be separated in the FRR method.

A front separation mechanism may be provided between a sheet separation mechanism and a paper sheet-feeding unit in order to improve sheet separation performance. As the front separation mechanism, for example, a type of a front separation mechanism which enables a sheet to abut against an inclined surface portion is known. A fixed friction portion configured with a friction pad is provided in the inclined surface portion.

However, when the sheets are strongly adhered to one another, insufficient efficiency of front separation may be caused in the front separation mechanism in which a fixed friction portion is provided in the inclined surface portion.

### DESCRIPTION OF THE DRAWINGS

FIG. 1 illustrates a sectional schematic diagram of an example of a configuration of an image forming apparatus of a first exemplary embodiment.

FIG. 2 illustrates a planar schematic diagram of main units of the image forming apparatus of the first exemplary embodiment.

FIGS. 3A and 3B illustrate sectional views taken along lines IIIA-IIIA and IIIB-IIIB in FIG. 2.

FIG. 4 illustrates a perspective schematic diagram of an example of a configuration of a resistance application member of the image forming apparatus of the first exemplary embodiment.

FIG. 5 illustrates a block diagram of an example of a configuration of a control system of the image forming apparatus of the first exemplary embodiment.

FIG. 6 illustrates a flowchart of an example of operations during printing of the image forming apparatus of the first exemplary embodiment.

FIG. 7 illustrates a diagram for explaining operations of the image forming apparatus of the first exemplary embodiment.

FIGS. 8A and 8B illustrate other diagrams for explaining the operations of the image forming apparatus of the first exemplary embodiment.

FIG. 9 illustrates a flowchart of an example of operations during printing of an image forming apparatus of a modification example (first modification example) of the first exemplary embodiment.

FIG. 10 illustrates a perspective schematic diagram of an example of a configuration of a resistance application member of an image forming apparatus of a second exemplary embodiment.

FIG. 11 illustrates a block diagram of an example of a configuration of a control system of the image forming apparatus of the second exemplary embodiment.

FIG. 12 illustrates a flowchart of an example of operations during printing of the image forming apparatus of the second exemplary embodiment.

FIG. 13 illustrates a sectional schematic diagram of an example of a configuration of a resistance application member of an image forming apparatus of a third exemplary embodiment.

FIGS. 14A and 14B illustrate a sectional schematic diagram of an example of a configuration of main units of an image forming apparatus of a fourth exemplary embodiment.

### DETAILED DESCRIPTION

A problem to be solved by the exemplary embodiment is to provide an image forming apparatus and an image forming method capable of improving front separation performance.

In general, according to one embodiment, an image forming apparatus includes a sheet accommodation unit, a paper sheet-feeding unit, an inclined surface portion, a resistance application member, and a transport unit. The sheet accommodation unit stacks sheets. The paper sheet-feeding unit feeds the sheets from the sheet accommodation unit. The inclined surface portion is provided in the paper sheet-feeding direction of the sheets. The resistance application member includes a protruding portion that protrudes more than the inclined surface portion. The transport unit is provided on the downstream side of the inclined surface portion in a transportation direction of the sheets. The transport unit transports the sheets.

### First Exemplary Embodiment

In the following, an image forming apparatus of a first exemplary embodiment will be described with reference to the accompanying drawings.

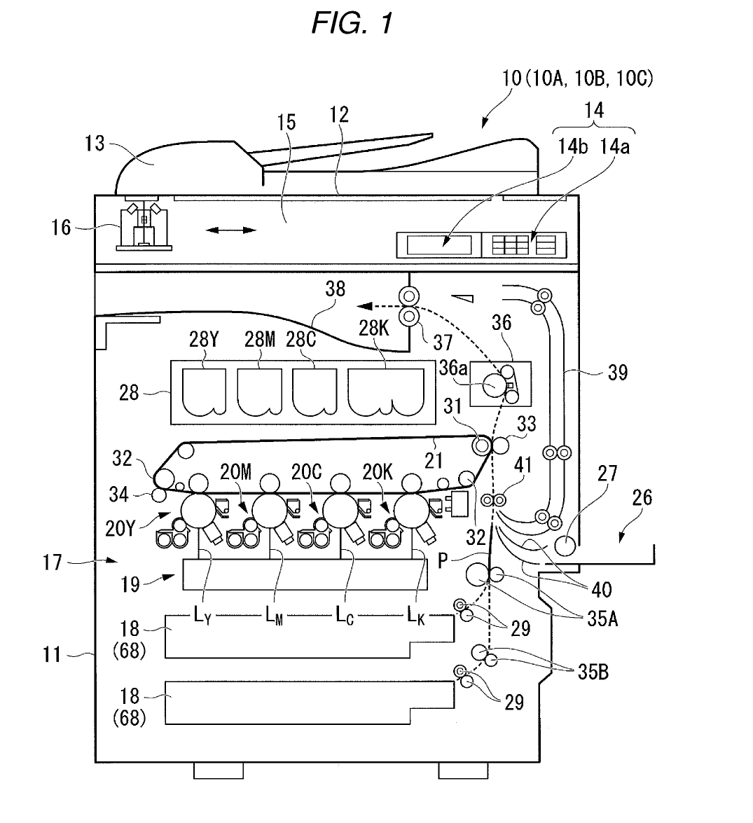

FIG. 1 is a sectional schematic diagram of an example of a configuration of an image forming apparatus of a first exemplary embodiment. In FIG. 1, for an easy-to-understand, dimensions and shapes of respective members are exaggerated or simplified (The same applies to FIG. 1 to FIGS. 14A and 14B).

As illustrated in FIG. 1, an image forming apparatus 10 of the first exemplary embodiment is, for example, a multi-function peripherals (MFP), a printer, and a copying machine. In the following description, an example of a case where the image forming apparatus 10 is the MFP will be described.

An original platen 12 including transparent glass is provide on an upper part of a main body 11 of the image forming apparatus 10. An automatic original transport unit (automatic document feeder: ADF) 13 is provided on the original platen 12. An operation unit 14 is provided on an upper part of the main body 11. The operation unit 14 includes an operation panel 14a having various keys and a touch panel type display unit 14b.

A scanner unit 15 which is a reading device is provided on the lower part of the ADF 13. The scanner unit 15 reads an original transmitted by the ADF 13 or an original placed on the original platen 12. The scanner unit 15 generates image data of the original. For example, the scanner unit 15 includes an image sensor 16. For example, the image sensor 16 may be a contact type image sensor.

The image sensor 16 moves along the original platen 12 when reading an image of the original placed on the original platen 12. The image sensor 16 reads 1 page of an original by reading one line by one line.

The image sensor 16 reads the original transmitted to a fixed position illustrated in FIG. 1 when reading an image of the original transmitted by the ADF 13.

The main body 11 of the image forming apparatus 10 includes a printer unit 17 in a center part in the height direction. The main body 11 includes a paper sheet-feeding cassette 18 (sheet accommodation unit) and a manual paper sheet-feeding unit 26 in the lower part thereof.

The paper sheet-feeding cassette 18 is disposed inside the main body 11. The number of the paper sheet-feeding cassettes 18 may be an appropriate number of one or more. In the example illustrated in FIG. 1, two paper sheet-feeding cassettes 18 are disposed and overlap each other in the vertical direction.

The manual paper sheet-feeding unit 26 protrudes to the lateral side of the main body 11 below a reverse transport path 39 which will be described later.

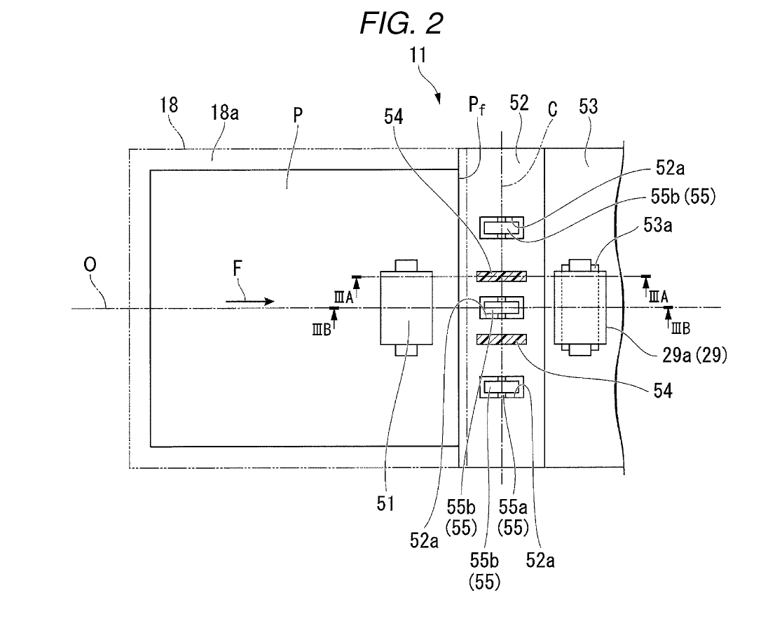

Each paper sheet-feeding cassette 18 and the manual paper sheet-feeding unit 26 accommodate sheet P having various sizes. Each paper sheet-feeding cassette 18 and the manual paper sheet-feeding unit 26 accommodate sheet P having various sizes in the center-referenced position. The sheets P having various sizes are aligned with the central axial line O (see FIG. 2) of a width orthogonal to the transportation direction by setting the central axial line O as a prescribed position.

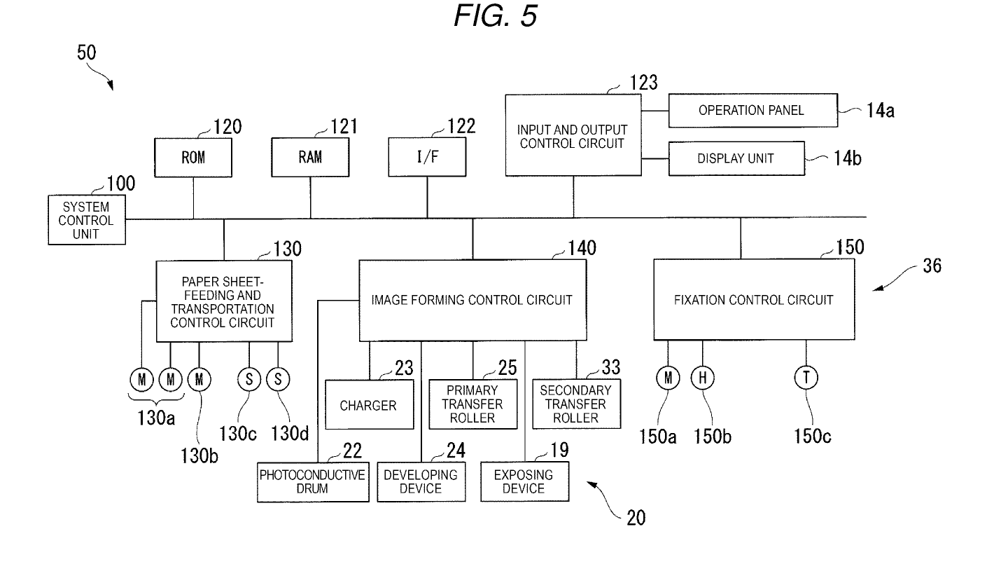

A size of the sheets P accommodated in each paper sheet-feeding cassette 18 and the manual paper sheet-feeding unit 26 is detected by a paper size detection mechanism (not illustrated). The paper size detection mechanism notifies a system control unit 100 (see FIG. 5), which will be described later, the size of the sheet P.

Different types of sheets P may be accommodated in each paper sheet-feeding cassette 18 and the manual paper sheet-feeding unit 26. Examples of types of the sheets P include types distinguished by thicknesses of the sheets P.

Types of the sheets P accommodated in each paper sheet-feeding cassette 18 and the manual paper sheet-feeding unit 26 may be input by an operation through, for example, an operation panel 14a or a display unit 14b. The type of the sheet P input by an operation is notified to a system control unit 100 which will be described later.

In the main body 11, a transportation mechanism 29 (transport unit) is disposed in the vicinity of each paper sheet-feeding cassette 18. The transportation mechanism 29 feeds a sheet P fed from the paper sheet-feeding cassette 18 to a body transport path. The transportation mechanism. 29 has an appropriate configuration in which the sheets P can be prevented from being subjected to multiple-feeding. For example, a configuration of the FRR paper sheet-feeding method may be used as the configuration of the transportation mechanism 29.

The manual paper sheet-feeding unit 26 includes a manual transportation mechanism 27. The manual transportation mechanism 27 takes out the sheet P one by one from the manual paper sheet-feeding unit 26 and transmits the sheet P to the body transport path.

In the following description, a direction orthogonal to the transportation direction of the sheet P along the transportation surface of the sheet P is referred to as a “transport orthogonal direction” in the image forming apparatus 10.

A printer unit 17 forms an image on the sheet P based on image data read by the scanner unit 15 or image data created by a personal computer or the like. The printer unit 17 is, for example, a tandem type color printer.

The printer unit 17 includes image forming units 20Y, 20M, 20C, and 20K of respective colors of yellow(Y), magenta(M), cyan(C), and black(K), an exposing device 19, and an intermediate transfer belt 21.

The image forming units 20Y, 20M, 20C, and 20K are disposed below the intermediate transfer belt 21. The image forming units 20Y, 20M, 20C, and 20K are disposed in parallel along from the upstream side to the downstream side in the movement direction (a direction from left side of FIG. 1 toward right side thereof) of the lower side of the intermediate transfer belt 21.

The exposing device 19 irradiates the image forming units 20Y, 20M, 20C, and 20K with exposure light L_{Y}, L_{M}, L_{C}, and L_{K}, respectively.

The exposing device 19 may be configured to generate laser scanning beam as exposure light. The exposing device 19 may be configured to include a solid state scanning element such as an LED which generates exposure light.

The respective image forming units 20Y, 20M, 20C, and 20K have the common configurations of except that toner colors are different from each other.

The respective image forming units 20Y, 20M, 20C, and 20K include a known electro-photographic device configuration in common with each other. For example, each of the image forming units 20Y, 20M, 20C, and 20K includes a photoconductive drum. A charger, a developing device, a primary transfer roller, a cleaner, a blade, and the like are disposed along a rotation direction of the photoconductive drum around each photoconductive drum.

The charger uniformly electrifies the surface of the photoconductive drum. The exposing device 19 generates exposure light modulated based on each color image data. Exposure light exposes the surface of the photoconductive drum. The exposing device forms an electrostatic latent image on the photoconductive drum. The developing device supplies a toner to the photoconductive drum by a developing roller to which developing bias is applied. The developing device develops the electrostatic latent image on the photoconductive drum. The cleaner includes a blade abutting on the photoconductive drum. The blade removes the toner remaining on the surface of the photoconductive drum.

As illustrated in FIG. 1, a toner cartridge 28 is disposed on the upper part of the image forming units 20Y, 20M, 20C, and 20K.

The toner cartridge 28 supplies the toner to each of developing devices of the image forming units 20Y, 20M, 20C, and 20K. The toner cartridge 28 includes toner cartridges 28Y, 28M, 28C, and 28K. The toner cartridges 28Y, 28M, 28C, and 28K accommodate toners of yellow, magenta, cyan, and black, respectively.

The intermediate transfer belt 21 is circularly moved. The intermediate transfer belt 21 is stretched out between a driving roller 31 and a plurality of driven rollers 32.

The intermediate transfer belt 21 is in contact with each of photoconductive drums of the image forming units 20Y, 20M, 20C, and 20K from above the image forming units 20Y, 20M, 20C, and 20K in the figure.

In the intermediate transfer belt 21, a primary transfer roller of each of the image forming units 20Y, 20M, 20C, and 20K is disposed inside the intermediate transfer belt 21 at the position opposing the photoconductive drum.

When a primary transfer voltage is applied, each primary transfer roller primarily transfers the toner image on the photoconductive drum to the intermediate transfer belt 21. The photoconductive drum configures an image carrier holding a toner image thereon until the sheet is transported from the developing position to the primary transfer position.

The driving roller 31 opposes the secondary transfer roller 33 by nipping the intermediate transfer belt 21 between the driving roller 31 and the secondary transfer roller 33. An abutment portion abutting the intermediate transfer belt 21 and the secondary transfer roller 33 configures a secondary transfer position. The driving roller 31 rotates the intermediate transfer belt 21. The rotated intermediate transfer belt 21 configures an image carrier holding a toner image thereon until the sheet is transported from the primary transfer position to the secondary transfer position.

When the sheet P passes through the secondary transfer position, a secondary transfer voltage is applied to the secondary transfer roller 33. When the secondary transfer voltage is applied to the secondary transfer roller 33, the secondary transfer roller 33 secondarily transfers the toner image to the sheet P on the intermediate transfer belt 21.

As illustrated in FIG. 1, a belt cleaner 34 is disposed in the vicinity of the driven roller 32. The belt cleaner 34 removes the transfer toner remaining on the intermediate transfer belt 21 from the intermediate transfer belt 21.

Transportation rollers 35B and 35A and a resist roller 41 are provided on a body transport path extending from each paper sheet-feeding cassette 18 to the secondary transfer roller 33. The transportation roller 35B transports the sheet P taken out from a lower-stage paper sheet-feeding cassette 18 toward the transportation roller 35A. The transportation roller 35A transports the sheets P taken out from a lower-stage paper sheet-feeding cassette 18 and an upper-stage paper sheet-feeding cassette 18 toward the resist roller 41, respectively.

The resist roller 41 arranges the position of the tip of the sheet P transported by the transportation roller 35A. When the tip of the toner image reaches the secondary transfer position, the resist roller 41 transports the sheet P such that the tip of a transfer area of the toner image in the sheet P reaches the secondary transfer position. The transfer area of the toner image is an area obtained by excluding an area in which void is formed at an end in the sheet P.

A transport path is formed between the manual transportation mechanism 27 and the resist roller 41 by a transportation guide 40. The manual transportation mechanism 27 transports the sheet P taken out from the manual paper sheet-feeding unit 26 toward the transportation guide 40. The sheet P moved along the transportation guide 40 reaches the resist roller 41.

A fixing device 36 is disposed on the downstream side (upper side in the figure) of the secondary transfer roller 33 in the transportation direction of the sheet P.

The transportation roller 37 is disposed on the downstream side (left upper side in the figure) of the fixing device 36 in the transportation direction of the sheet P. The transportation roller 37 discharges the sheet P to a paper discharge unit 38.

The reverse transport path 39 is disposed on the downstream side (right side in the figure) of the fixing device 36 in the transportation direction of the sheet P. The reverse transport path 39 turns over the sheet P and guides the sheet P to the secondary transfer roller 33. The reverse transport path 39 is used in performing double-sided printing.

The fixing device 36 fixes the toner image on the sheet P. The fixing device 36 heats and presses the toner image on the sheet P to fix the toner image.

For example, a configuration in which a known roller fixing method is adopted may be used as a configuration of the fixing device 36. For example, a configuration in which a known belt fixing method is adopted may be used as a configuration of the fixing device 36. The fixing device 36 includes at least a heat roller 36a, a heating source (heater 150b which will be described later. see FIG. 5), and a temperature detection sensor (thermistor 150c which will be described later. see FIG. 5). The heat roller 36a heats the toner image. The heating source heats the heat roller 36a. The temperature detection sensor detects a temperature of the heat roller 36a.

Next, a configuration related to paper sheet-feeding from the paper sheet-feeding cassette 18, front separation, and paper sheet-feeding will be described.

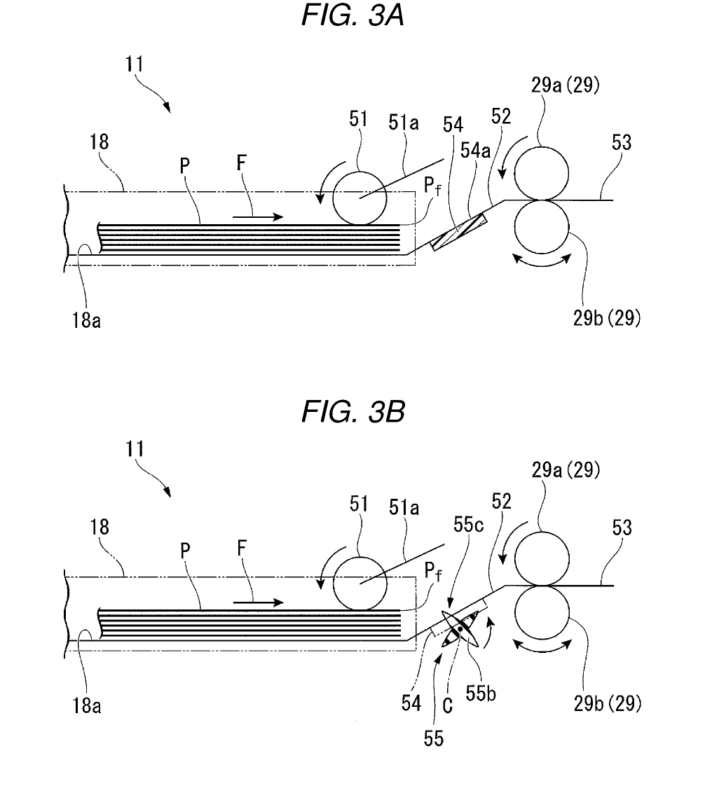

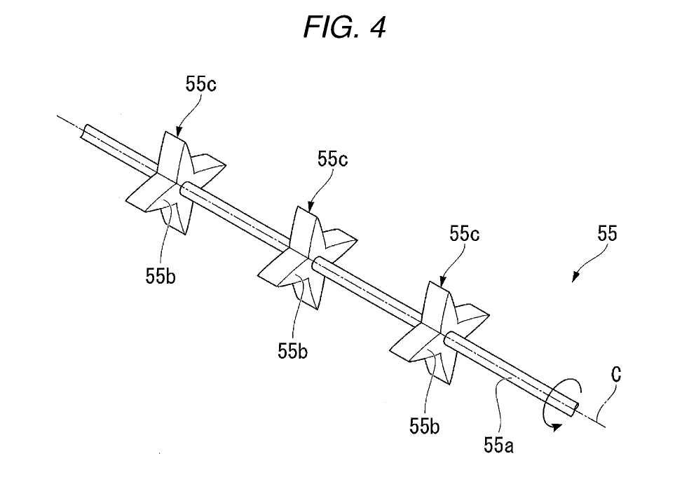

FIG. 2 illustrates a planar schematic diagram of main units of the image forming apparatus of the first exemplary embodiment. FIGS. 3A and 3B are sectional views taken along lines A-A and B-B in FIG. 2. FIG. 4 is a perspective schematic diagram illustrating an example of a configuration of a resistance application member of the image forming apparatus of the first exemplary embodiment.

As illustrated in FIG. 2 and FIGS. 3A and 3B, a pickup roller 51 (paper sheet-feeding unit) is disposed above the paper sheet-feeding cassette 18. The sheets P are stacked on the bottom portion 18a of the paper sheet-feeding cassette 18. The pickup roller 51 is supported on the main body 11 through an arm 51a (see FIGS. 3A and 3B). The arm 51a supports the pickup roller 51 so as to make it possible for the pickup roller 51 to contact the upper surface of the sheet P stacked in the paper sheet-feeding cassette 18. The pickup roller 51 pushes the upper surface of the sheet P at least at the start of paper-feeding.

The pickup roller 51 is rotated by a driving motor (not illustrated) which will be described later. The pickup roller 51 is rotated to feed the sheet P in a paper sheet-feeding direction F. In FIG. 2 and FIGS. 3A and 3B, the paper sheet-feeding direction F is a direction extending from the left side toward the right side in the figures. However, when a transporting route of the sheet P is changed by a transportation guide, an advancing direction of the sheet P along the transporting route is the paper sheet-feeding direction F.

As illustrated in FIGS. 3A and 3B, an inclined surface portion 52 is disposed in the front of the paper sheet-feeding cassette 18 in the paper sheet-feeding direction F. The inclined surface portion 52 opposes the tip P_{f} in the paper sheet-feeding direction F of the sheet P stacked in the paper sheet-feeding cassette 18 in the paper sheet-feeding direction F. The tip P_{f} of the sheet P which moves in the paper sheet-feeding direction F may abut on the inclined surface portion 52.

The inclined surface portion 52 is inclined in such a way that a height from the bottom portion 18a is increased as the inclined surface portion 52 advances to the paper sheet-feeding direction F.

The inclined surface portion 52 is configured with a low friction material with which the sheet P can be smoothly slid. The inclined surface portion 52 may be formed with, for example, metal, resin, or the like.

As illustrated in FIG. 2, a friction pad 54 (friction member) is disposed inside the inclined surface portion 52 along the inclined surface portion 52. In the present embodiment, the friction pad 54 is disposed so as to be symmetrical with respect to the central axial line O of the sheet P in a transport orthogonal direction.

The number of disposed friction pads 54 is not limited. One or more friction pads 54 are disposed in an area through which all sheets P capable of being accommodated in the paper sheet-feeding cassette 18. For example, when a width of the sheet P capable of being accommodated in the paper sheet-feeding cassette 18 in the transport orthogonal direction is greater than or equal to W, one or more friction pads 54 are disposed within a range of ±W/2 from the central axial line O.

It is more preferable that the friction pad 54 is disposed in a range of a roller width of the pickup roller 51 in the transport orthogonal direction.

In the present embodiment, as an example, two friction pads 54 are disposed in the range of the roller width of the pickup roller 51. In the present embodiment, the outline in plan view of the friction pad 54 is a rectangle. The longer sides of the friction pad 54 of the present embodiment are disposed parallel to the paper sheet-feeding direction F.

As illustrated in FIG. 3A, the friction pad 54 includes a frictional surface 54a on a surface thereof. The frictional surface 54a is substantially the same as the surface of the inclined surface portion 52.

The position of the friction pad 54 with respect to the inclined surface portion 52 is fixed. The friction pad 54 may be stuck to a concave portion formed in the inclined surface portion 52. In this case, as the friction pad 54, a sheet shaped member having the thickness which is substantially the same as the depth of the concave portion may be used.

Otherwise, the friction pad 54 may be stuck to a rear surface side of the inclined surface portion 52 such that the friction pad 54 is exposed to a through-hole formed in the inclined surface portion 52 from the rear surface side. In this case, a sheet shaped member including a step shaped portion that protrudes into the through-hole may be used in the friction pad 54.

The friction pad 54 is formed with a material whose frictional coefficient to the sheet P is larger than that to the inclined surface portion 52. For example, the friction pad 54 may be formed with urethane rubber, cork, or the like.

As illustrated in FIG. 2, an opening portion 52a is provided in a portion except for the position where the friction pad 54 is disposed in the inclined surface portion 52. The number of opening portions 52a is not particularly limited. For example, in the example illustrated in FIG. 2, a total of three opening portions 52a one of which is provided at a site located between the friction pads 54 and two of which are provided respectively at other sites located at the outer sides than the friction pads 54 in the transport orthogonal direction.

On the rear surface side of the inclined surface portion 52, a paddle 55 (resistance application member) is disposed.

As illustrated in FIG. 4, the paddle 55 includes a shaft portion 55a and an impeller portion 55b.

The shaft portion 55a is disposed parallel to the transport orthogonal direction. The shaft portion 55a is supported by a bearing portion (not illustrated). The shaft portion 55a is rotatable around the central axial line C (rotational axis) of the shaft portion 55a. An end portion of the shaft portion 55a is connected with a driving motor through a transmission mechanism (not illustrated) which will be described later.

The impeller portion 55b rotates together with the shaft portion 55a. The impeller portion 55b extends radially from the shaft portion 55a. The impeller portion 55b is tapered toward the tip side of its extending direction. A tip-protruding portion 55c is formed on each tip portion in the impeller portion 55b. A ridge line of the tip in the tip-protruding portion 55c is parallel to the central axial line C of the shaft portion 55a.

The number of tip-protruding portions 55c in the impeller portion 55b is not particularly limited. For example, in the example illustrated in FIG. 4, the tip-protruding portion 55c is formed at four sites equally dividing a circumference with the shaft portion 55a as a center. In the example illustrated in FIG. 4, the impeller portion 55b is a cross shape when viewed from the axial direction of the shaft portion 55a.

However, the impeller portion 55b may be extended radially across three or less sites or five or more sites and the tip-protruding portion 55c may be formed on each tip portion.

The impeller portion 55b is provided at three sites separated from each other in the axial direction of the shaft portion 55a.

The impeller portion 55b is formed with a material having large frictional resistance to the sheet P so as to make it possible to apply frictional resistance to the sheet P when abutting the tip P_{f} of the sheet P. It is more preferable that the impeller portion 55b is formed with the material having flexibility. When the impeller portion 55b has flexibility, a fold, a tear or the like becomes difficult to occur in the sheet P when the impeller portion 55b abuts on the sheet P. It is more preferable that the impeller portion 55b is formed with a shape and material having flexibility in a circumferential direction of the shaft portion 55a.

For example, preferable materials as the impeller portion 55b include an ethylene propylene rubber (EPDM) and the like.

As illustrated in FIG. 2, each impeller portion 55b in the paddle 55 is disposed in a positional relation that each impeller portion 55b overlaps each opening portion 52a in the inclined surface portion 52 in plan view.

The opening portion 52a is formed at a position substantially parallel to the friction pad 54 in the transport orthogonal direction. Each tip-protruding portion 55c protrudes upward from a position overlapping an area in which the friction pad 54 is disposed, when viewed from the transport orthogonal direction. The paddle 55 is disposed in an area within a range in which the friction pad 54 is disposed in the paper sheet-feeding direction F.

As illustrated in FIGS. 3A and 3B, the tip of each tip-protruding portion 55c of the impeller portion 55b protrudes above the surface of the friction pad 54 during a period of time when the paddle 55 turns around once.

The transportation guide 53 is smoothly connected to the upper end portion of the inclined surface portion 52. In FIGS. 3A and 3B, the transportation guide 53 is extended in horizontal direction for schematic illustration. However, the transportation guide 53 may be extended upward obliquely in the figure such that the transportation guide 53 slides from the upper end of the inclined surface portion 52.

The transportation guide 53 guides transportation of the sheet P moved along the inclined surface portion 52. An upper side transportation guide (not illustrated) may be included in the transportation guide 53. The upper side transportation guide (not illustrated) guides the sheet P from above.

As illustrated in FIG. 2, an opening portion 53a is formed at a central portion across the central axial line O in the transportation guide 53. The opening portion 53a is formed at a position surrounding nip of the transportation mechanism 29.

In the example illustrated in FIG. 3A, the transportation mechanism 29 includes a paper sheet-feeding roller 29a and a separation roller 29b.

The paper sheet-feeding roller 29a abuts on the sheet P which moves on the transportation guide 53 from above the transportation guide 53. The paper sheet-feeding roller 29a is rotated by a driving motor which will be described later. The paper sheet-feeding roller 29a rotates in a direction (counterclockwise direction in the figure) in which the sheet P is moved to the paper sheet-feeding direction F.

The separation roller 29b abuts on the sheet P which moves on the transportation guide 53 from below the transportation guide 53. The separation roller 29b is rotated in a direction (clockwise direction in the figure) opposite to that of the paper sheet-feeding roller 29a by a driving motor which will be described later. The paper sheet-feeding roller 29b is connected to the driving motor through a torque limiter. When torque greater than or equal to a predetermined value is generated, the torque limiter of the separation roller 29b makes the separation roller 29b slip with respect to the rotational drive shaft (not illustrated) of the separation roller 29b. For example, if a single sheet P advances into between the paper sheet-feeding roller 29a and the separation roller 29b, in the torque limiter of the separation roller 29b, torque applied to the torque limiter becomes a predetermined value or more by the frictional force between the sheet P and the separation roller 29b. The separation roller 29b is made to slip with respect to the rotational drive shaft (not illustrated). In this case, the sheet P advanced into between the paper sheet-feeding roller 29a and the separation roller 29b moves along the transportation guide 53 in the paper sheet-feeding direction F by the driving force from the paper sheet-feeding roller 29a.

If two or more sheets P advance into between the paper sheet-feeding roller 29a and the separation roller 29b, a slip occurs between the sheets P. Since torque generated in the separation roller 29 is less than a predetermined value, the separation roller 29b is locked with respect to the rotational drive shaft (not illustrated). In this case, among two or more sheets P advanced into between the paper sheet-feeding roller 29a and the separation roller 29b, an uppermost sheet P is moved along the transportation guide 53 in the paper sheet-feeding direction F by a driving force from the paper sheet-feeding roller 29a. On the other hand, among two or more sheets P advanced into between the paper sheet-feeding roller 29a and the separation roller 29b, a lower-most sheet P returns in a direction opposite to the paper sheet-feeding direction F by a driving force from the separation roller 29b.

The sheets P between the upper-most part and the lower-most part are moved in one of the paper sheet-feeding direction F and the direction opposite to the paper sheet-feeding direction F according to the magnitude of a friction force.

According to the transportation mechanism 29, if two sheets P are advanced into, only the single uppermost sheet can be separated and fed. However, according to the transportation mechanism 29, if three or more sheets P are advanced into, there is a risk that two or more sheets P are fed.

Next, a configuration of a control system of the image forming apparatus 10 will be described.

FIG. 5 is a block diagram of an example of a configuration of a control system of the image forming apparatus of the first exemplary embodiment. However, in FIG. 5, for an easy-to-understand, members distinguished by subscripts Y, M, C, and K are collectively represented by reference symbols in which subscripts are deleted. For example, the image forming unit 20 represents the image forming units 20Y, 20M, 20C, and 20K. The photoconductive drum 22, the charger 23, the developing device 24, and the primary transfer roller 25 also represent members included in respective image forming units 20Y, 20M, 20C, and 20K.

As illustrated in FIG. 5, a control system 50 (control unit) includes a system control unit 100, a read only memory (ROM) 120, a random access memory (RAM) 121, an interface (I/F) 122, an input and output control circuit 123, a paper sheet-feeding and transportation control circuit 130, an image forming control circuit 140, and a fixation control circuit 150.

The system control unit 100 controls the entirety of the image forming apparatus 10. The system control unit 100 executes a program stored in the ROM 120 or the RAM 121 which will be described later to realize processing function for image formation.

As an apparatus configuration of the system control unit 100, a processor, for example, a CPU may be used.

The ROM 120 stores a control program controlling basic operations of image formation processing, control data and the like.

The RAM 121 is a working memory in the control system 50. For example, the control program or control data of the ROM 120 is loaded onto the RAM 121 as needed. Furthermore, in the RAM 121, image data sent from the input and output control circuit 123 or data sent from the system control unit 100 are temporarily stored.

An I/F 122 performs communication with a connection mechanism which connects to the main body 11. For example, the scanner unit 15 is communicably connected to the I/F 122. The I/F 122 is connectible with external devices. Examples of external devices include a user terminal, facsimile terminal and the like.

The input and output control circuit 123 controls the operation panel 14a and the display unit 14b. The input and output control circuit 123 send an operation input received from the operation panel 14a and the display unit 14b to the system control unit 100.

The paper sheet-feeding and transportation control circuit 130 controls a driving system included in the main body 11. For example, driving motors 130a and 130b are included in the driving system.

The driving motor 130a drives each transportation mechanism 29, the transportation rollers 35A and 35B, the manual transportation mechanism 27, and the resist roller 41. It is more preferable that the plurality of driving motors 130a are provided.

The driving motor 130b (driving unit) drives the paddle 55. It is more preferable that the plurality of driving motors 130b are provided.

A plurality of sensors 130c and 130d are electrically connected to the paper sheet-feeding and transportation control circuit 130. For example, the plurality of sensors 130c are sheet detection sensors. Respective sensors 130c disposed on the body transport path in the main body 11, or inside the paper sheet-feeding cassette 18 and the manual paper sheet-feeding unit 26. Respective sensors 130c detect the presence or absence of the sheet P in the position where the sensors 130c are disposed. The sensors 130c are disposed at the positions at which it can be detected whether the sheet P passes through the transportation mechanism 29 or not until the sheet P reaches the resist roller 41.

The detected outputs of the respective sensors 130c are transmitted from the paper sheet-feeding and transportation control circuit 130 to the system control unit 100.

The paper sheet-feeding and transportation control circuit 130 controls the driving motor 130a based on control signals from the system control unit 100 and the detected outputs of the sensors 130c.

For example, the plurality of sensors 130d are multiple-feeding detection sensors. The sensors 130d detect whether the sheet P fed from the paper sheet-feeding cassette 18 is subjected to multiple-feeding. As the sensors 130d, appropriate sensors that detect the thickness of the sheet P are used. For example, ultrasonic sensors that detect the thickness of the sheet P may be used as the sensors 130d.

Respective sensors 130d detect whether the sheet P is subjected to multiple-feeding before the tip P_{f} of the sheet P abuts on the paddle 55. For example, the respective sensors 130d are disposed closer to the paper sheet-feeding cassette 18 than a position where the tip P_{f} of the sheet P abuts on the paddle 55 in the inclined surface portion 52.

The detected outputs of the respective sensors 130d are transmitted from the paper sheet-feeding and transportation control circuit 130 to the system control unit 100. For example, if the sensors 130d detect the thickness of the sheet P, information of the thickness of the sheet P fed from each the paper sheet-feeding cassette 18 in advance is stored in the system control unit 100. If the thickness of the sheet P detected by the sensor 130d exceeds the stored thickness of the sheet P, the system control unit 100 determines that the sheet P is subjected to multiple-feeding. The system control unit 100 can determine the number of sheets subjected to multiple-feeding based on information of the thickness of the sheet P from the sensors 130d.

The paper sheet-feeding and transportation control circuit 130 controls the driving motor 130b based on control signals from the system control unit 100 and detected outputs of the sensors 130d.

The image forming control circuit 140 respectively controls the photoconductive drum 22, the charger 23, the exposing device 19, the developing device 24, the primary transfer roller 25, and the secondary transfer roller 33 based on the control signal from the system control unit 100.

The fixation control circuit 150 controls operations of the fixing device 36 based on control signals from the system control unit 100. A driving motor 150a, a heater 150b, and a thermistor 150c are communicably connected to the fixation control circuit 150.

The driving motor 150a rotates the heat roller 36a according to control of the fixation control circuit 150. The heater 150b heats the heat roller 36a according to control of the fixation control circuit 150. A thermistor 150c detects a temperature of the heat roller 36a. Information of the temperature detected by the thermistor 150c is sent to the fixation control circuit 150. The fixation control circuit 150 controls the temperature of the heat roller 36a based on information of the temperature from the thermistor 150c.

Details of control performed by the control system 50 will be described together with operations of the image forming apparatus 10.

Next, an image forming method of the present embodiment will be described. The image forming method of the present embodiment is performed using the image forming apparatus 10. The image forming method of the present embodiment is related to operations for preventing multiple-feeding of the sheet P.

Regarding operations of the image forming apparatus 10 during printing, description will be made mainly on the image forming method of the present embodiment.

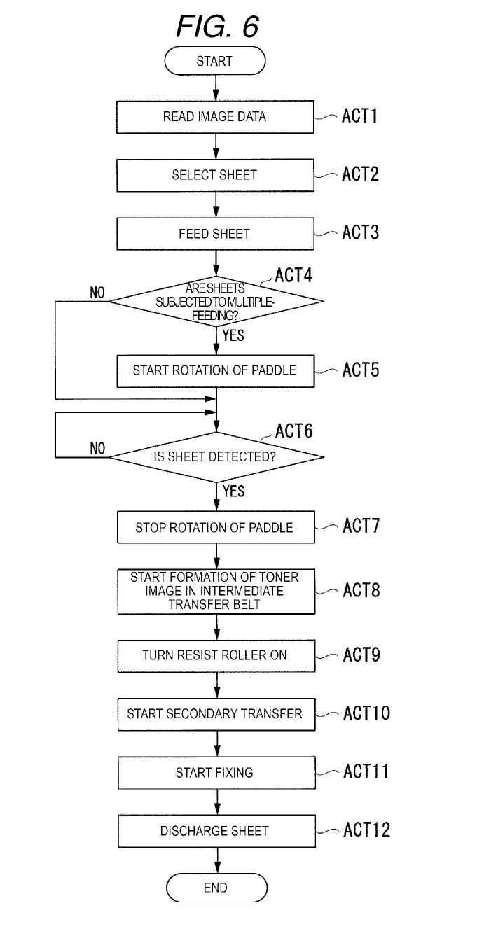

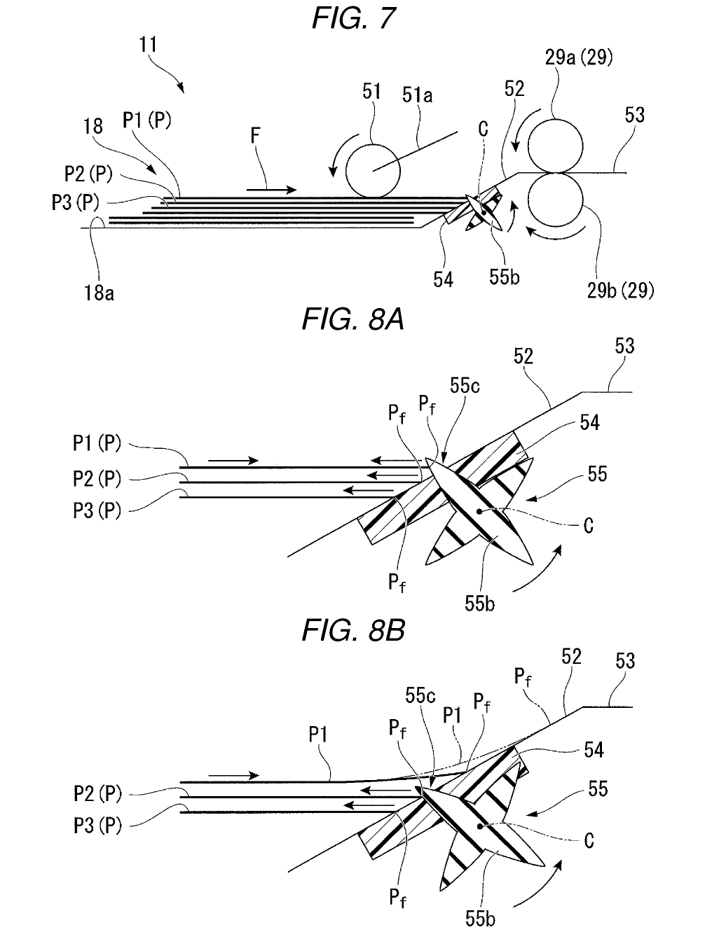

FIG. 6 is a flowchart illustrating an example of operations during printing of the image forming apparatus of the first exemplary embodiment. FIGS. 7 and 8 are diagrams for explaining the operations of the image forming apparatus of the first exemplary embodiment.

The image forming apparatus 10 executes ACT1 to ACT12 illustrated in FIG. 6 according to a flow illustrated in FIG. 6 to print an image on the sheet P.

In ACT1, the image forming apparatus 10 reads image data.

For example, reading of image data may be performed by causing the scanner unit 15 to read an original. In this case, an operator places the original on the original platen 12 or the ADF 13. Thereafter, the operator performs inputting of an operation to start scanning of the scanner unit 15 through the operation unit 14. Image data read by the scanner unit 15 is stored in the RAM 121 through the I/F 122.

For example, image data may be read from an external device connected to the image forming apparatus 10 through the I/F 122. Image data read from the external device is stored in the RAM 121.

Printing setting information is included in image data. In printing setting information, at least pieces of information of a paper sheet size, a printing direction, and the number of sheets to be printed used for printing image data are included. If image data is read from the scanner unit 15, information of the original read by the scanner unit 15 or information set by the operation unit 14 in advance are used as the pieces of information of the paper sheet size, the printing direction, and the number of sheets to be printed.

In printing setting information, for example, color designation, pieces of information of magnification condition, double-sided printing designation, printing paper sheet designation, and sheet accommodation unit designation may be included. The printing paper sheet designation specifies a type of the sheet P.

However, the printing setting information may be changed through the operation unit 14 by an operator. Printing setting information changed by the operator is overwritten to a storage location of printing setting information in the RAM 121.

If information needed for printing is not included in printing setting information, default printing settings stored previously in the RAM 121 are used.

In the following description, as an example, an example of a case where image data is read from the external device will be described.

After image data is read, ACT2 is performed.

In ACT2, the system control unit 100 selects the sheet P used for image formation. The system control unit 100 selects the sheet P based on printing setting information stored in the RAM 121.

Here, for an easy-to-understand, description was made on an example of the case where the sheet P that matches printing setting information is accommodated in the sheet accommodation unit. When the sheet P that matches printing setting information is not present in the sheet accommodation unit, the system control unit 100 transmits a warning message to the display unit 14b and an external device. The system control unit 100 urges an operator to reset printing setting information.

Furthermore, the system control unit 100 sends a control signal causing a warm-up operation of the fixing device 36 to be started to the fixation control circuit 150. The fixation control circuit 150 starts the warm-up operation of the fixing device 36.

In this way, ACT2 is ended.

The fixation control circuit 150 monitors a temperature of the heat roller or the like in the fixing device 36. When temperature of the heat roller or the like is controlled to a predetermined value, the fixation control circuit 150 detects the end of the warm-up operation. When the warm-up operation is ended, the fixation control circuit 150 sends a transportation permission signal of the sheet P to the system control unit 100.

When ACT2 is ended, ACT3 is performed. In ACT3, feeding of the sheet P selected in the ACT2 is performed. Specifically, the system control unit 100 sends a control signal which causes start of feeding of the sheet P to the paper sheet-feeding and transportation control circuit 130. The paper sheet-feeding and transportation control circuit 130 performs control by which the sheet P is fed from the sheet accommodation unit accommodating the selected sheet P based on the control signal from the system control unit 100. For example, in a case of the sheet P accommodated in the upper-stage paper sheet-feeding cassette 18, driving of the pickup roller 51 corresponding to the upper-stage paper sheet-feeding cassette 18 and the transportation mechanism 29 is started.

The transportation mechanism 29 continues the feeding operation, as will be described later, until the tip P_{f} of the sheet P abuts on the resist roller 41 and accordingly, predetermined deflection is formed in the sheet P.

Furthermore, the paper sheet-feeding and transportation control circuit 130 drives the sheet transport units disposed on the body transport path from the transportation mechanism to the resist roller 41. For example, the paper sheet-feeding and transportation control circuit 130 drives the transportation roller 35A.

In this way, ACT3 is ended.

Here, the movement of the sheet P in ACT3 will be described.

As illustrated in FIG. 7, when the pickup roller 51 starts to rotate, the uppermost sheet P starts to move in the paper sheet-feeding cassette 18 in the paper sheet-feeding direction F. When the uppermost sheet P is moved, a frictional force is applied from the uppermost sheet P to a sheet P immediately below the sheet P toward the paper sheet-feeding direction F. Strictly speaking, there is a possibility that an attraction force, for example, an electrostatic force is also applied between the sheets P in addition to the frictional force. The attraction force between the sheets P is also a force that impedes the relative movement between the sheets P. In the following description, description will be made by regarding that the attraction force is also included in the frictional force.

If the magnitude of the frictional force corresponds to a certain level, the sheet P immediately below the uppermost sheet P is also moved in the paper sheet-feeding direction F. Similarly, there is a possibility that a plurality of sheets P below the uppermost sheet P are moved by the frictional force in the paper sheet-feeding direction F.

In the following description, as an example, an example of a case where three sheets of the sheet P1, a sheet P2, and a sheet P3 from the uppermost sheet P are likely to be moved in the paper sheet-feeding direction F in order from the sheet P1 will be described.

For example, operations of the following representative cases I, II, and III depending on the magnitude of the frictional force between the respective sheets P may be considered.

The case I corresponds to a case where the frictional force between the sheets P1, P2, and P3 is small. In the case I, only the sheet P1 is moved by the pickup roller 51 in the paper sheet-feeding direction F.

The case II corresponds to a case where the frictional force between the sheets P1, P2, and P3 is a medium range. In the case II, the sheets P1, P2, and P3 are moved by the pickup roller 51 in the paper sheet-feeding direction F. However, when the sheets P1, P2, and P3 abut on the inclined surface portion 52, as illustrated in FIG. 7, respective tips P_{f} of the sheets P1, P2, and P3 are separated in a state of being obliquely deviated along the inclination of the inclined surface portion 52.

The case III corresponds to a case where the frictional force between the sheets P1, P2, and P3 is large. In the case III, the sheets P1, P2, and P3 are moved by the pickup roller 51 in the paper sheet-feeding direction F. However, the sheets P1, P2, and P3 are integrally moved. The sheets P1, P2, and P3 are not separated in a state of being obliquely deviated along the inclination of the inclined surface portion 52 even when the sheets P1, P2, and P3 abut on the inclined surface portion 52.

As illustrated in FIG. 6, ACT4 is performed after ACT5 in the present embodiment.

In ACT4, the system control unit 100 determines whether the sheet P is subjected to multiple-feeding, based on the detected output of the sensor 130d. The sensor 130d sends information of the thickness of the sheet P abutting the inclined surface portion 52 to the system control unit 100.

If the number of the sheets P abutting the inclined surface portion 52 is greater than one sheet, the system control unit 100 determines that the sheet P is subjected to multiple-feeding, based on the thickness information sent from the sensor 130d.

When it is determined that the sheet P is subjected to multiple-feeding (ACT4: YES), ACT5 is performed.

When it is determined that the sheet P is not subjected to multiple-feeding (ACT4: NO), ACT6 is performed.

In this way, ACT4 is ended.

For example, in a case of the case I, it is determined that the sheet P is not subjected to multiple-feeding. For example, in a case of the cases II and III, it is determined that the sheet P is subjected to multiple-feeding.

In ACT5, the rotation of the paddle 55 is started by the system control unit 100. The system control unit 100 sends a control signal which causes a driving force of the driving motor 130b to be transmitted to the paddle 55 to the paper sheet-feeding and transportation control circuit 130. The paper sheet-feeding and transportation control circuit 130 performs control which starts transmission of the driving force of the driving motor 130b to the paddle 55. The paper sheet-feeding and transportation control circuit 130 may turn the rotation of the driving motor 130b ON to thereby start transmission of the driving force. Otherwise, the paper sheet-feeding and transportation control circuit 130 may turn a clutch of a transmission mechanism or the like between the driving motor 130b and the paddle 55 ON to thereby start transmission of the driving force.

As illustrated in FIG. 7, the paddle 55 rotates counterclockwise in the figure.

In the present embodiment, execution of ACT5 is limited to a case where multiple-feeding is generated as in the cases II and III.

As illustrated in FIG. 8A, respective tip-protruding portions 55c of the paddle 55 are moved toward the sheets P which are subjected to multiple-feeding from a direction opposite to the paper sheet-feeding direction F, on the inclined surface portion 52. The tip-protruding portions 55c repeatedly abut on respective tips P_{f} of the sheets P by the rotation of the paddle 55. The tip-protruding portion 55c squeezes respective tips P_{f} of the sheets P from top toward downward when being moved to the rear surface side of the inclined surface portion 52.

Respective tips P_{f} of superposed sheets P are separated by repeatedly receiving external forces from the tip-protruding portions 55c. Respective tips P_{f} of the sheet P are separated from each other in the stacking direction by being subjected to such a separation operation.

For example, as illustrated in FIG. 8B, the uppermost sheet P1 rides over the tip-protruding portions 55c of the paddle 55 to go forward. On the other hand, the tip P_{f} of the sheet P2 immediately below the uppermost sheet P1 is pushed downward by the tip-protruding portions 55c being rotated. In this case, a gap is opened in the tip portions of the sheets P1 and P2. The contact area is reduced in tip portions of the sheets P1 and P2. The frictional force is reduced in tip portions of the sheets P1 and P2. The sheet P2 prevents the advance by the tip-protruding portion 55c and a separation movement of the sheet P1 in the paper sheet-feeding direction F becomes easy.

There is a possibility that the sheet P2 rides over the tip-protruding portions 55c of the paddle 55 to go forward before long. Also, in this case, a distance between the tips P_{f} of the sheets P1 and P2 is increased while being temporarily stopped by the tip-protruding portion 55c. When distance between the tips P_{f} of the sheets P1 and P2 is increased, separation becomes easy in the transportation mechanism 29.

FIGS. 8A and 8B, although an abutting state of the case II is depicted, the separation operation by the paddle 55 is substantially similar also in a case of the case III. For example, in the case of the case III, the positions of the tips of respective sheets P are separated and thus, the tip-protruding portions 55c move respective tips P_{f} of the sheets P from above toward downward in the stacking direction by its rotation. The tip-protruding portion 55c is formed with a material whose frictional force to the sheet P is large and thus, a gap is opened between layers in the respective tips P_{f} of the sheets P by such a movement of the tip-protruding portion 55c. The frictional force of the tip portions of the sheets P1, P2, and P3 is reduced. Similar to the case II, the sheets P1, P2, and P3 become a state of being obliquely abutted to the inclined surface portion 52. Accordingly, similar to the case II, a separation movement of the sheet P1 from the sheet P2 becomes easy.

In ACT6, it is detected whether the tip P_{f} of the sheet P passes through a nip of the transportation mechanism 29. The system control unit 100 monitors a detected output of the sensor 130c disposed between the transportation mechanism 29 and the transportation rollers 35A and 35B.

When the system control unit 100 detects, by the detected output of the sensor 130c, that the sheet P passed through (ACT6: YES), ACT7 is performed.

When the system control unit 100 does not detect, by the detected output of the sensor 130c, that the sheet P passed through (ACT6: NO), ACT6 is further performed.

In ACT7, it becomes to a state where the rotation of the paddle 55 is temporarily stopped by the system control unit 100. The system control unit 100 sends the control signal causing transmission of the driving force of the driving motor 130b to be stopped to the paper sheet-feeding and transportation control circuit 130.

If the paddle 55 is being rotated, the paper sheet-feeding and transportation control circuit 130 stops transmission of the driving force of the driving motor 130b to thereby stop the rotation of the paddle 55. If the paddle 55 is not rotated, the paper sheet-feeding and transportation control circuit 130 does not particularly perform control and causes a stopping state of the paddle 55 to continue.

In the timing at which ACT7 is executed, the sheet P1 is moved by the transportation mechanism 29 and thus the operation of the pickup roller 51 is not required. The system control unit 100 stops also the driving of the pickup roller 51.

In this way, ACT7 is ended.

ACT7 is executed such that resistance to the sheet P by the rotation of the paddle 55 is reduced, and thus, a transportation load of the sheet P1 is reduced. Furthermore, a period of time during which the paddle 55 abuts on the sheet P becomes small and thus, a possibility that damage to the sheet P is generated is reduced.

After ACT7, ACT8 is performed. In ACT8, forming of the toner image in the intermediate transfer belt 21 is started. Specifically, the system control unit 100 determines that a transportation permission signal is received from the fixation control circuit 150. When the transportation permission signal is received, the system control unit 100 sends a control signal causing toner image formation to be stated to the paper sheet-feeding and transportation control circuit 130, the image forming control circuit 140, and the fixation control circuit 150.

The paper sheet-feeding and transportation control circuit 130, the image forming control circuit 140, and the fixation control circuit 150 respectively start control operations in parallel.

In this way, ACT8 is ended.

The image forming control circuit 140 causes the image forming units 20Y, 20M, 20C, and 20K to start an image formation process in this order. In respective image forming units 20Y, 20M, 20C, and 20K, an electrostatic latent image is written on a surface of each photoconductive drum 22 by exposure light L_{Y}, L_{M}, L_{C}, and L_{K} from the exposing device 19. Each electrostatic latent image is developed by each developing device 24.

The developed toner image is primarily transferred to the intermediate transfer belt 21 by each primary transfer roller 25. It is performed in such away that respective toner image forming areas overlap with each other by respective primary transfer. Respective toner images stacked on the intermediate transfer belt 21 are transported toward a secondary transfer position by the intermediate transfer belt 21.

In parallel with such an operation of the image forming control circuit 140, ACT9 is performed. In ACT9, the driving motor 130a which drives the resist roller 41 is driven by the paper sheet-feeding and transportation control circuit 130 at the timing when the toner image reaches a predetermined position. The rotation of the resist roller 41 is started by the driving motor 130a.

If the transportation mechanism. 29 is stopped, the paper sheet-feeding and transportation control circuit 130 drives the transportation mechanism 29 together with the resist roller 41.

In this way, ACT9 is ended.

After ACT9 is ended, when the tip of the sheet P reaches the secondary transfer position, ACT10 is performed.

In ACT10, the toner image on the intermediate transfer belt 21 is secondarily transferred to the sheet P. Specifically, the image forming control circuit 140 applies a secondary transfer voltage to the secondary transfer roller 33 in a period of time during which the tip of the sheet P reaches the secondary transfer position. The toner image is secondarily transferred to the sheet P which passes through the secondary transfer position. The sheet P passing through the secondary transfer position is transported toward the fixing device 36 along the body transport path.

After the rear end of the sheet P passed through the secondary transfer position, the image forming control circuit 140 stops application of the secondary transfer voltage.

When the sheet P which passed through the secondary transfer position advances into the fixing device 36, ACT11 is performed. In ACT11, the toner image is fixed onto the sheet P by the fixing device 36.

When the sheet P enters the nip of the fixing device 36, the sheet P is heated with a fixing temperature. The fixing temperature is controlled to be constant by the fixation control circuit 150. Furthermore, the sheet P is pushed by the fixing device 36. The toner image adhered to the sheet P is thermally heated onto the sheet P.

The sheet P is discharged to the outside of the fixing device 36.

In this way, ACT11 is ended.

After ACT11, ACT12 is performed.

In ACT12, the sheet P is discharged. The sheet P discharged from the fixing device 36 reaches the transportation roller 37. The transportation roller 37 discharges the sheet P to the paper discharge unit 38.

In this way, image formation in a single sheet P is ended.

In a printing job, in a case where an image is formed on a plurality of sheets P, ACT3 described above is executed on a following sheet P, by control of the system control unit 100, at a prescribed time after the rear end of a preceding sheet P passed through the transportation mechanism 29. In the following, ACT4 to ACT12 described above are similarly repeated on the following sheet P.

In image formation of the following sheet P, the toner image is formed in the intermediate transfer belt 21 at the timing with a fixed paper sheet interval spaced apart from the rear end of the preceding sheet P.

When the number of images designated by printing setting are formed on the following sheet P, the system control unit 100 stops the sheet transport unit in the image forming apparatus 10. In this way, the printing job is ended.

Next, action of the image forming apparatus 10 will be described in detail.

As illustrated in FIG. 8A, in ACT5 described above, when the sheets P1, P2, and P3 reach an area in which the friction pad 54 is disposed, the respective tips P_{f} which are obliquely separated respectively abut on the friction pad 54. The friction pad 54 is configured with a material whose frictional force to the sheet P is large. The respective tips P_{f} of the sheets P1, P2, and P3 receive the frictional force from the friction pad 54 in a direction opposite to the paper sheet-feeding direction F.

The sheet P1 receives a driving force larger than the frictional force, which is caused from the sheet P2 and the friction pad 54, from the pickup roller 51. The sheet P1 is more advanced than the sheet P2 to the paper sheet-feeding direction F. Here, if the sheet P2 is stopped by the frictional force from the friction pad 54, the sheet P1 is separated from the sheet P2 only by action of the inclined surface portion 52 and the friction pad 54.

However, when the frictional force received in the paper sheet-feeding direction F from the sheet P1 is larger than the frictional force from the friction pad 54 to the sheet P2, the sheet P2 is kept in a multiple-feeding state in which the sheet P2 is moved together with the sheet P1 in the paper sheet-feeding direction F continues.

In the present embodiment, when it is determined in ACT4 that the multiple-feeding is generated, the rotation of the paddle 55 is started in ACT5.

The tip-protruding portions 55c of the paddle 55 repeatedly abut on respective tips P_{f} of the sheets P1, P2, and P3. The paddle 55 applies a resistance load intermittently to the respective tips P_{f} through the tip-protruding portions 55c.

In the present embodiment, the tip-protruding portions 55c squeeze respective tips P_{f} of the stacked sheets P1, P2, and P3 from above toward downward in the stacking direction. In this case, a gap between respective sheets P is opened by the friction force between the sheets P and the surface of the tip-protruding portions 55c. Especially, when respective tips P_{f} of the sheets P1, P2, and P3 get over the tip-protruding portion 55c, jumping-up by stiffness of the sheet P occurs and thus, the gap is more reliably opened. Furthermore, if the tip-protruding portions 55c have flexibility, trembling vibration is generated during frictional. Furthermore, when the tip P_{f} of the sheet P rides over the tip-protruding portions 55c, the sheet P becomes easy to jump up due to elasticity of the tip-protruding portion 55c.

By doing as described above, adhesion between the sheets P is reduced in the tip portions of respective sheets P and thus, the separation of the sheets P from each other is facilitated.

The separation state is formed by the paddle 55 such that synergetic effect of separation action of the friction pad 54 along the inclination of the inclined surface portion 52 is improved.

In the image forming apparatus 10 of the present embodiment, the paddle 55 is included in addition to the inclined surface portion 52 and the friction pad 54 and thus, front separation performance is improved compared to a case where the paddle 55 is not included.

The front separation performance is improved and accordingly, a possibility that three or more sheets P advance into the transportation mechanism 29 is remarkably reduced. The number of sheets P to be advanced into the transportation mechanism 29 is made less than or equal to two sheets to thereby make it possible for the transportation mechanism 29 to feed only the upper most sheet P1 of the paper sheet-feeding cassette 18 to the body transport path.

### First Modification Example

A modification example (first modification example) of the present embodiment will be described.

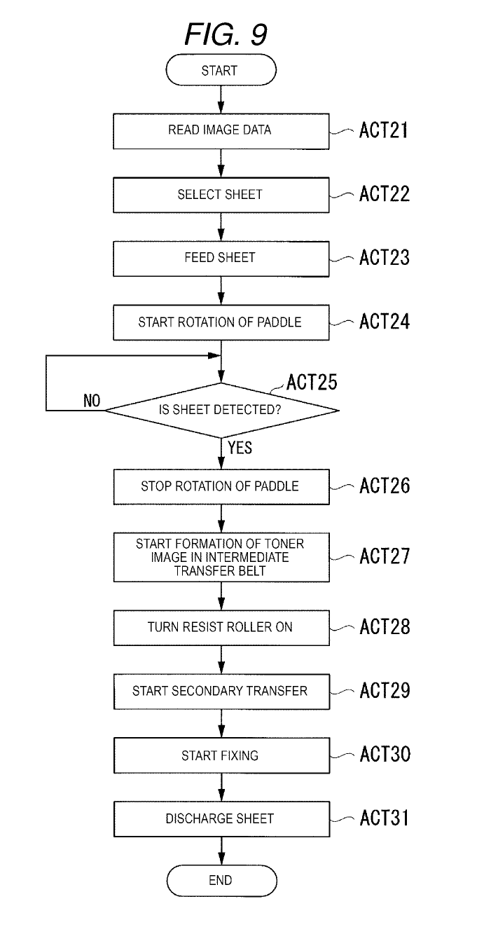

FIG. 9 is a flowchart illustrating an example of operations during printing of an image forming apparatus of a modification example (first modification example) of the first exemplary embodiment.

The present modification example is a modification example related to control of driving of the paddle 55. As an apparatus configuration of the image forming apparatus 10, a configuration similar to that of the first exemplary embodiment may be used.

The present modification example may be applied irrespective of the type of the sheet P, may be applied by being limited to a case where the sheet P is thick paper or the like. The present modification example may be applied to a case where the sheet is fed from a specific paper sheet-feeding cassette 18.

If the present modification example is applied to all sheets P capable of being mounted on a specific paper sheet-feeding cassette 18 of the image forming apparatus 10, the sensor 130d corresponding to the specific the paper sheet-feeding cassette 18 may be deleted.

In the following description, regarding operations of the present modification example performed by using the image forming apparatus 10 in the first exemplary embodiment described above, description will be made mainly on matters different from those of the first exemplary embodiment.

In the present modification example, the image forming apparatus 10 executes ACT21 to ACT31 illustrated in FIG. 9 according to a flow illustrated in FIG. 9 to print an image on the sheet P.

In ACT21 to ACT23, the same operations as those of ACT1 to ACT5 in the first exemplary embodiment are performed, respectively.

In ACT24 performed after ACT23, similar to ACT5 described above, the rotation of the paddle 55 is started by control of the system control unit 100. The timing at which the paddle 55 is rotated is not particularly limited, as long as before the sheet P reaches the position of the paddle 55 on the inclined surface portion 52 by driving of the pickup roller 51.

In ACT25 to ACT31, the same operations as those of ACT5 to ACT12 in the first exemplary embodiment are performed, respectively.

In the present modification example, detection of multiple-feeding before the start of rotation of the paddle 55 as in the first exemplary embodiment is not performed. In the present modification example, the paddle 55 is rotated even if multiple-feeding is made and if multiple-feeding is not made, when the sheet P reaches the inclined surface portion 52.

According to the image forming apparatus 10 of the present modification example, it is possible for the separation operation by the paddle 55 to be performed on all sheets P accommodated in the paper sheet-feeding cassette 18.

According to the present modification example, the paddle 55 is rotated and thus, similar to the first exemplary embodiment, front separation performance is improved.

### Second Exemplary Embodiment

An image forming apparatus of a second exemplary embodiment will be described.

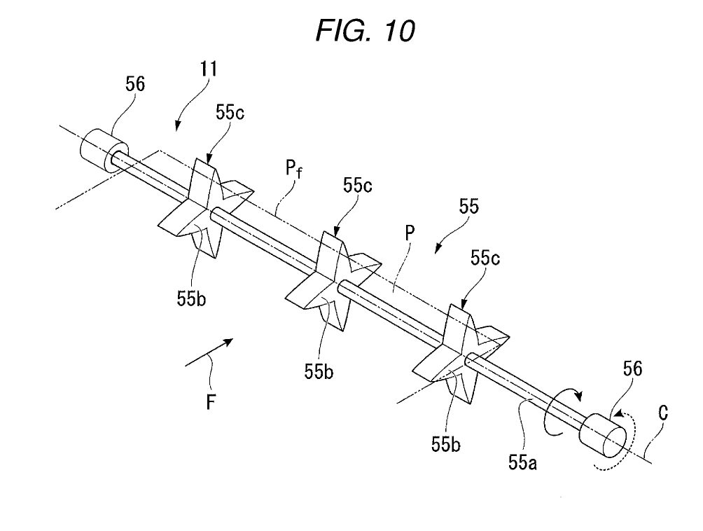

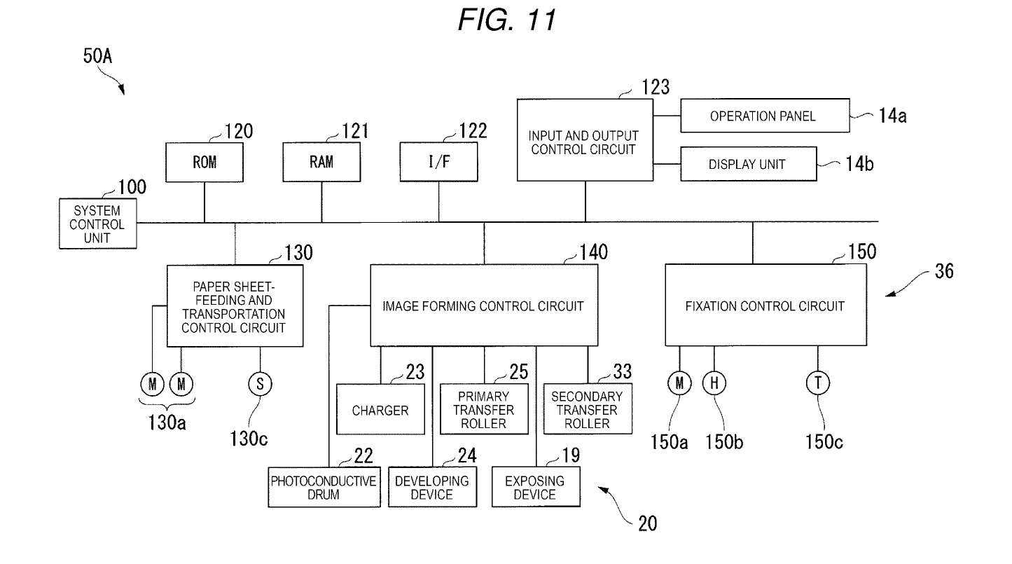

FIG. 10 is a perspective schematic diagram illustrating an example of a configuration of a resistance application member of an image forming apparatus of a second exemplary embodiment. FIG. 11 is a block diagram illustrating an example of a configuration of a control system of the image forming apparatus of the second exemplary embodiment.

In FIG. 1, the image forming apparatus 10A of the present embodiment is illustrated.

In the image forming apparatus 10A of the present embodiment, as illustrated in FIG. 10, a damper 56 is added to the image forming apparatus 10 of the first exemplary embodiment (see FIG. 10) and the control system 50A (see FIG. 11) is included instead of the control system 50 of the image forming apparatus 10.

In the following, description will be made mainly on matters different from those of the first exemplary embodiment.

As illustrated in FIG. 10, the damper 56 supports both ends of the paddle 55 in the axial direction in the present embodiment. In the present embodiment, the position where the paddle 55 is disposed is the same as that of the first exemplary embodiment. However, in the present embodiment, the tip-protruding portions 55c of the paddle 55 is formed in a shape in which at least one of the tip-protruding portions 55c protrudes from the opening portion 52a of the inclined surface portion 52, in a state where all rotation states of the paddle 55. For example, in a case of the impeller portion 55b having four impellers of which an example is illustrated in FIG. 10, a shape of the impeller portion 55b is set to a shape in which from one or two tip-protruding portions 55c protrude from each opening portion 52a.

The damper 56 supports the shaft portion 55a of the paddle to be rotatable. However, the damper 56 generates resistance in a direction opposed to rotation of the shaft portion 55a.

For example, as the damper 56, a rotation damper using a viscous resistance body may be used. For example, in the damper 56, an elastic member which generates an elasticity resistance force according to the rotation of the shaft portion 55a may be included.

As illustrated in FIG. 11, the control system 50A has a configuration in which the driving motor 130b and the sensor 130c are deleted from the control system 50 in the first exemplary embodiment.

In the paddle 55 of the present embodiment, when the sheet P abuts on the tip-protruding portion 55c, the tip-protruding portion 55c rotates in a direction where the sheet P moves in the paper sheet-feeding direction F on the inclined surface portion 52 due to a paper sheet-feeding force received by the sheet P. In this case, rotation resistance is generated by the damper 56.

In the present embodiment, according to the paddle 55, when the sheet P abuts on the tip-protruding portion 55c and is moved in the paper sheet-feeding direction F, a resistance force is applied to the sheet P from the tip-protruding portion 55c. The resistance force from the tip-protruding portion 55c includes frictional resistance in the surface of the tip-protruding portion 55c and rotation resistance from the damper 56.

Regarding operations of the image forming apparatus 10A, description will be made mainly on matters different from those of the first exemplary embodiment.

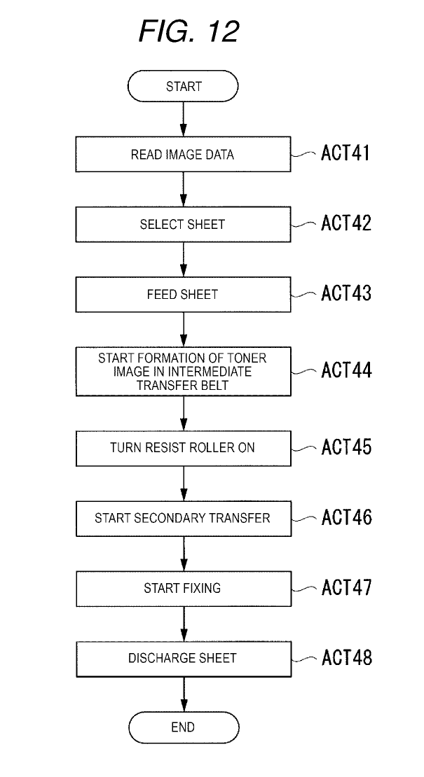

FIG. 12 is a flowchart illustrating an example of operations during printing of the image forming apparatus of the second exemplary embodiment.

The image forming apparatus 10A of the present embodiment executes ACT41 to ACT48 illustrated in FIG. 12 according to the flow illustrated in FIG. 12 to print an image on the sheet P.

In the image forming apparatus 10A of the present embodiment, as will be understood from the configuration described above, control in which the paddle 55 is rotated by the driving motor is not performed. The image forming apparatus 10A of the present embodiment is operated similarly as first exemplary embodiment except for another operation related to the operation in which the paddle 55 is rotated by the driving motor in the first exemplary embodiment.

Specifically, in ACT41 to ACT43, the same operations as those of ACT1 to ACT5 in the first exemplary embodiment are performed, respectively. In ACT44 to ACT48, the same operations as those of ACT8 to ACT12 in the first exemplary embodiment are performed, respectively.

In the first exemplary embodiment, the impeller portions 55b of the paddle 55 are rotated by the driving motor 130b such that the separation operation is performed in the paddle 55.

In contrast, in the present embodiment, the sheet P abuts on the impeller portions 55b that protrude on the inclined surface portion 52 such that resistance is applied to the sheet P from the paddle 55.

As illustrated in FIG. 10, the tip P_{f} of the sheet P abuts on the tip-protruding portions 55c which are in a stationary state. In this case, the tip P_{f} of the sheet P receives an external force which causes the sheet P to be rolled upward along the tip-protruding portion 55c. By a reaction to the external force, the tip-protruding portion 55c is moved from the tip P_{f} of the sheet P toward the paper sheet-feeding direction F. The paddle 55 rotates in a solid line arrow in the figure.

Both ends of the shaft portion 55a of the paddle 55 are supported by the damper 56. The damper 56 generates a resistance force in a direction (see broken line arrow in the figure) opposite to the rotation of the shaft portion 55a in the solid line arrow direction.

As such, in the present embodiment, dynamic resistance which occurs according to the movement of the sheet P is applied from the paddle 55 in the sheet P, in addition to static frictional resistance in the friction pad 54.

According to the present embodiment, the paddle 55 is rotated by the movement of the sheet P and thus, front separation performance is improved by dynamic resistance which occurs at the time of the rotation.

### Third Exemplary Embodiment

An image forming apparatus of a third exemplary embodiment will be described.

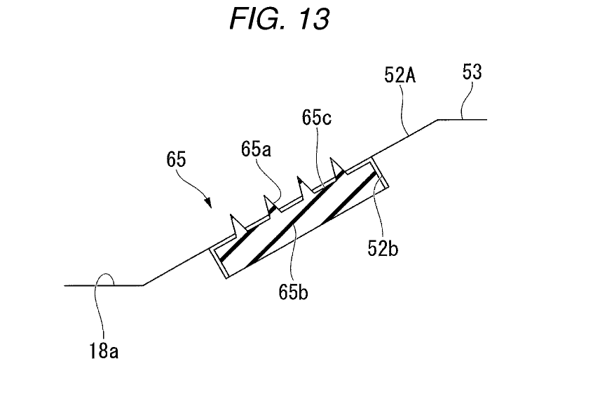

FIG. 13 is a sectional schematic diagram illustrating an example of a configuration of a resistance application member of an image forming apparatus of a third exemplary embodiment.

In FIG. 1, an image forming apparatus 10B of the present embodiment is illustrated.

The image forming apparatus 10B of the present embodiment, as illustrated in FIG. 13, includes an inclined surface portion 52A and a resistance pad 65 (resistance application member), instead of the inclined surface portion 52 and the paddle 55 of the image forming apparatus 10 of the first exemplary embodiment. Furthermore, the image forming apparatus 10B includes a control system 50A (see FIG. 11) which is the same as in the second exemplary embodiment, instead of the control system 50 of the image forming apparatus 10.

In the following, description will be made mainly on matters different from those of the first exemplary embodiment.

As illustrated in FIG. 13, the inclined surface portion 52A includes a concave portion 52b instead of the opening portion 52a in the first exemplary embodiment. The concave portion 52b accommodates the resistance pad 65 which will be described later.

The resistance pad 65 includes a base portion 65b and a protruding portion 65a.

The base portion 65b is accommodated within the concave portion 52b. The base portion 65b is formed in a sheet shape accommodated in the concave portion 52b. In the base portion 65b, a surface 65c is lower than the surface of the inclined surface portion 52A in a state being accommodated in the concave portion 52b.

The protruding portion 65a protrudes from the surface 65c toward the outside of concave portion 52b. In the present embodiment, the plurality of protruding portions 65a are provided on the surface 65c.

It is more preferable that the protruding portions 65a have a shape tapered toward a protruding direction. For example, the protruding portions 65a may be configured with a protruding body of which a triangular cross section illustrated in FIG. 13 is extended along the depth direction. For example, the protruding portions 65a may be configured with a conical projection having the triangular cross section illustrated in FIG. 13. For example, the protruding body and the conical projection may be mixed in the protruding portions 65a.

For example, respective protruding portions 65a may include different cross sectional shape.

A protruding height of the protruding portion 65a from the inclined surface portion 52 is at least higher than the thickness of a single sheet P. The protruding height of the protruding portion 65a from the inclined surface portion 52 may be higher that a total thickness of the sheets P which may be subjected to multiple-feeding.

If the plurality of protruding portions 65a are provided, the protruding height of the protruding portion 65a from the inclined surface portion 52 may include variation.

It is more preferable that the protruding portion 65a has flexibility by which the protruding portion 65a bends by being abutted to the sheet P. For example, the protruding portion 65a may be formed with elastic material such as rubber, elastomer, or the like.

With the configuration as described above, according to the resistance pad 65 of the present embodiment, when the tip P_{f} of the sheet P abuts on the protruding portion 65a, the tip P_{f} is caught by the protruding portion 65a. The protruding portion 65a is pushed by the fed sheets P. The protruding portion 65a bends in the paper sheet-feeding direction F. The protruding portion 65a generates a resistance force which resists the movement of the sheet P in the paper sheet-feeding direction F.

An elastic restoring force is increased as flexibility is increased in the protruding portion 65a. When the protruding portion 65a bends to a certain level, the protruding portion 65a is raised by an elastic restoring force. In this case, the protruding portion 65a pushes up the rear surface of the sheet P. Due to exertion of such a pushing-up force, it becomes easy to form a gap in the tip portion of the sheet P.

According to the protruding portion 65a of the resistance pad 65 in the present embodiment, when the sheet P abuts on the protruding portion 65a and is moved in the paper sheet-feeding direction F, a resistance force which resists the movement of the sheet P is exerted from the protruding portion 65a. The resistance force from the protruding portion 65a includes frictional resistance in the surface of the protruding portion 65a and resistance by the tip P_{f} of the sheet P being caught in the protruding portion 65a.

Operations of the image forming apparatus 10B are similar to those of the second exemplary embodiment.

In the first exemplary embodiment, the impeller portion 55b of the paddle 55 is rotated by the driving motor 130b such that the separation operation is performed in the paddle 55.

In contrast, in the present embodiment, the sheet P abuts on the protruding portion 65a protruding from the inclined surface portion 52 such that resistance is exerted to the sheet P from the resistance pad 65.

In the present embodiment, resistance generated according to the movement of the sheet P is exerted from the resistance pad 65 in the sheet P, in addition to a static frictional resistance in the friction pad 54.

According to the image forming apparatus 10B of the present embodiment, the protruding portion 65a protrudes from the resistance pad 65. According to the image forming apparatus 10B, resistance is generated when the tip P_{f} of the sheet P is caught in the protruding portion 65a and thus, front separation performance is improved.

### Fourth Exemplary Embodiment

An image forming apparatus of the fourth exemplary embodiment will be described.

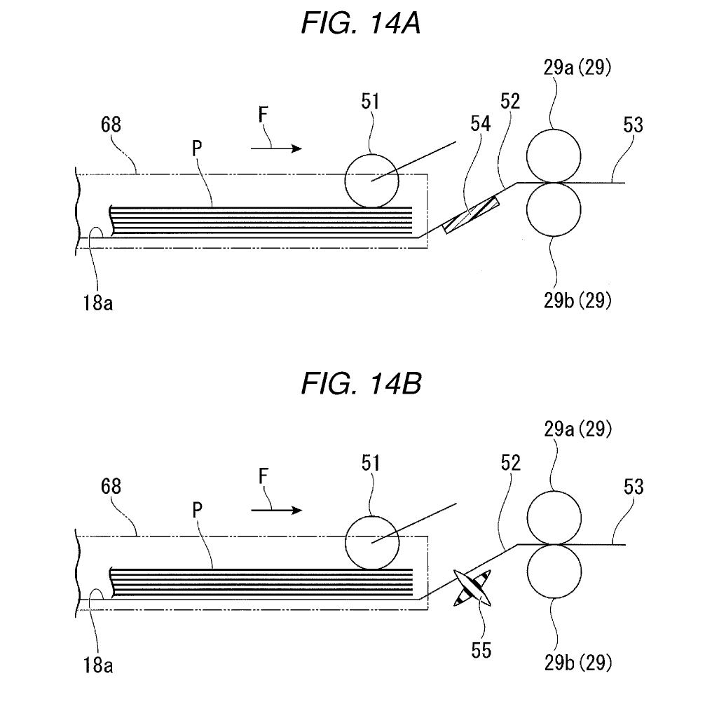

FIGS. 14A and 14B are sectional schematic diagrams illustrating an example of a configuration of main units of an image forming apparatus of a fourth exemplary embodiment.

In FIG. 1, an image forming apparatus 10C of the present embodiment is illustrated.

An image forming apparatus 10C of the present embodiment includes a paper sheet-feeding cassette 68 (sheet accommodation unit) instead of the paper sheet-feeding cassette 18 in the image forming apparatus 10 of the first exemplary embodiment.

In the following, description will be made mainly on matters different from those of the first exemplary embodiment.

As illustrated in FIGS. 14A and 14B, the paper sheet-feeding cassette 68 includes the inclined surface portion 52 and the paddle 55 inside of the paper sheet-feeding cassette 68 differently from the paper sheet-feeding cassette 18 of the first exemplary embodiment. Similar to the first exemplary embodiment, the friction pad 54 is provided in the inclined surface portion 52.

The inclined surface portion 52 and the paddle 55 are removable from the main body 11 of the image forming apparatus 10C together with the paper sheet-feeding cassette 68. The driving motor 130b (not illustrated) which drives the paddle 55 may be provided in the paper sheet-feeding cassette 68. Otherwise, the driving motor 130b may be provided in the main body 11. In this case, the driving motor 130b and the paddle 55 are connected by a joint which is detachable in a detaching and attaching direction of the paper sheet-feeding cassette 68.

According to the image forming apparatus 10C, similar to the first exemplary embodiment, the paddle 55 is included in addition to the inclined surface portion 52 and the friction pad 54.

According to the image forming apparatus 10C of the present embodiment, similar to the image forming apparatus 10 of the first exemplary embodiment, front separation performance is improved.

In the description of respective embodiments described above and the first modification example, an example of a case where the sheets fed from the paper sheet-feeding cassette are separated by the resistance application member is described. However, separation of the sheets by the resistance application member may also be performed also in the manual paper sheet-feeding unit.

In the description of the first modification example, an example of a case where the paddle 55 is rotated after feeding of the sheets P is started is described. However, the paddle 55 may be rotated until the tip P_{f} of the fed sheet P abuts on the paddle 55. For example, the rotation of the paddle 55 may also be started before paper sheet-feeding is started.

In the description of the third exemplary embodiment, an example in which the protruding portion of the resistance application member urges the sheet, which moves in the paper sheet-feeding direction, to a side opposite to the paper sheet-feeding direction by elasticity of the protruding portion itself is described. However, an urging force to the side opposite to the paper sheet-feeding direction may also be generated by a property of the protruding portion other than elasticity.

For example, an elastic member which generates an elastic restoring force according to the rotation of the paddle 55 may be provided instead of the damper 56 in the second exemplary embodiment. Examples of the elastic member include rubber, a spring, or the like.

Otherwise, in the second exemplary embodiment, a weight which shifts a center of gravity from a central axis of the shaft portion 55a may be provided in the paddle 55. In this case, if an external force from the sheet P is not exerted, the rotation position of the paddle 55 is kept constant by the force of gravity. However, when the sheet P pushes the tip-protruding portions 55c of the paddle 55, a gravity moment which resists the rotation is generated. The sheet P receives a dynamic resistance load from the paddle 55.

In the description of respective embodiments and respective modification examples described above, an example of a case where the friction member is provided in the inclined surface portion is described. However, if sufficient separation is performed by the resistance application member, the friction member may also be omitted.

According to at least one of the embodiments described above, it is possible to provide an image forming apparatus and an image forming method capable of improving front separation performance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An image forming apparatus comprising:
a sheet accommodation unit that stacks sheets;
a paper sheet-feeding unit that feeds the sheets from the sheet accommodation unit;
an inclined surface portion provided in a paper sheet-feeding direction of the sheets;
a resistance application member that includes a protruding portion that protrudes above the inclined surface portion and contacts the sheets as the sheets are feeding along the paper sheet-feeding direction, wherein respective tips of the sheets are separated from one another based on the protruding portion contacting the sheets; and
a transport unit that transports the sheets and is provided on a downstream side of the inclined surface portion in a transportation direction of the sheets.

2. The image forming apparatus according to claim 1, further comprising:
a friction member that includes a frictional surface and is disposed along the inclined surface portion,
wherein the resistance application member is disposed in an area within a range in which the friction member is disposed in the paper sheet-feeding direction of the sheets.

3. The image forming apparatus according to claim 1,
wherein the resistance application member is supported to be rotatable around a rotational axis orthogonal to the paper sheet-feeding direction.

4. The image forming apparatus according to claim 3, further comprising a driving unit which rotates the resistance application member around the rotational axis in a direction in which the protruding portion which protrudes above the inclined surface portion is moved to a side opposite to the paper sheet-feeding direction.

5. An image forming method comprising:
abutting sheets fed from a sheet accommodation unit on an inclined surface portion;
detecting, by a sensor, that the sheets are subjected to multiple-feeding; and
moving, by a driving motor, a resistance application member including a protruding portion which protrudes above the inclined surface portion toward tips of the sheets and performing front separation of the tips of the sheets.

6. The image forming method of claim 5, further comprising:
providing a friction member that includes a frictional surface and is disposed along the inclined surface portion, and
disposing the resistance application member in an area within a range in which the friction member is disposed in a paper sheet-feeding direction of the sheets.

7. The image forming method of claim 6, further comprising:
supporting the resistance application member to be rotatable around a rotational axis orthogonal to the paper sheet-feeding direction.

8. The image forming method of claim 5, further comprising:
rotating, by a driving unit, the resistance application member around a rotational axis in a direction in which the protruding portion which protrudes above the inclined surface portion is moved to a side opposite to a paper sheet-feeding direction.

9. A method, comprising:
facilitating stacking of sheets in a sheet accommodation unit;
feeding the sheets from the sheet accommodation unit;
contacting the sheets with a resistance application member as the sheets are fed along a paper sheet-feeding direction, wherein respective tips of the sheets are separated from one another based on a protruding portion of the resistance application member contacting the sheets, and wherein the protruding portion protrudes above an inclined surface portion located in the paper sheet-feeding direction of the sheets; and
transporting the sheets with a transport unit that is provided on a downstream side of the inclined surface portion in a transportation direction of the sheets.

10. The method of claim 9, further comprising:
providing a friction member that includes a frictional surface and is disposed along the inclined surface portion; and
disposing the resistance application member in an area within a range in which the friction member is disposed in the paper sheet-feeding direction of the sheets.

11. The method of claim 9, further comprising:
supporting the resistance application member to be rotatable around a rotational axis orthogonal to the paper sheet-feeding direction.

12. The method of claim 11, further comprising:
rotating, by a driving unit, the resistance application member around the rotational axis in a direction in which the protruding portion which protrudes above the inclined surface portion is moved to a side opposite to the paper sheet-feeding direction.
